(19) United States
(12) Patent Application Publication
(10) Pub. No.: US 2023/0230756 A1
(43) Pub. Date: Jul. 20, 2023

(54) LAMINATED COIL COMPONENT

(71) Applicant: TDK CORPORATION, Tokyo (JP)

(72) Inventors: Nobuyuki OKUZAWA, Tokyo (JP); Munehiro TAKAKU, Tokyo (JP); Kazuya TOBITA, Tokyo (JP); Teruhiro MITSUYASU, Tokyo (JP)

(73) Assignee: TDK CORPORATION, Tokyo (JP)

(21) Appl. No.: 18/153,659

(22) Filed: Jan. 12, 2023

(30) Foreign Application Priority Data
Jan. 17, 2022 (JP) 2022-005063

(51) Int. Cl. H01F 27/29; H01F 27/28; H01F 27/24

(52) U.S. Cl. CPC H01F 27/292; H01F 27/2804; H01F 27/24; H01F 2027/2809

(57) ABSTRACT

A laminated coil component includes an element body, a first terminal electrode and a second terminal electrode, and a coil, the coil includes a plurality of first wiring portions disposed on a main surface side and disposed side by side in a third direction, a plurality of second wiring portions disposed on a mounting surface side and disposed side by side in the third direction, and a plurality of first pillar portions and second pillar portions that extend in a second direction and connect the first wiring portion with the second wiring portion which correspond to each other, and a width of the second wiring portion in the third direction is smaller than a width of the first wiring portion in the third direction.

### TECHNICAL FIELD

The present disclosure relates to a laminated coil component.

### BACKGROUND

As a conventional laminated coil component, for example, one described in Patent Document 1 (Japanese Unexamined Patent Application Publication No. 2015-141945) is known. The laminated coil component described in Patent Document 1 includes an element body, a coil disposed in the element body, and a pair of terminal electrodes disposed on a mounting surface of the element body.

### SUMMARY

An object of one aspect of the present disclosure is to provide a laminated coil component capable of improving characteristics.

A laminated coil component according to one aspect of the present disclosure includes an element body having a pair of end surfaces facing each other in a first direction, a mounting surface and a main surface facing each other in a second direction, and a pair of side surfaces facing each other in a third direction, a pair of terminal electrodes disposed on the mounting surface of the element body, and a coil disposed in the element body and electrically connected to the pair of terminal electrodes, wherein the coil includes a plurality of first wiring portions disposed on the main surface side and disposed side by side in the third direction, a plurality of second wiring portions disposed on the mounting surface side and disposed side by side in the third direction, and a plurality of connection portions that extend in the second direction and connect the first wiring portions with the second wiring portions which correspond to each other, and a width of the second wiring portion in the third direction is smaller than a width of the first wiring portion in the third direction.

In the laminated coil component, a stray capacitance may be formed between the terminal electrodes disposed on the mounting surface and the second wiring portion disposed on the mounting surface side. In such a configuration, in the laminated coil component according to one aspect of the present disclosure, the width of the second wiring portion in the third direction is smaller than the width of the first wiring portion in the third direction. Thus, in the laminated coil component, the stray capacitance formed between adjacent second wiring portions can be reduced. Therefore, in the laminated coil component, a decrease in self-resonant frequency can be suppressed. Therefore, in the laminated coil component, a Q characteristic in a high frequency range can be improved. As a result, characteristics in the laminated coil component can be improved.

A laminated coil component according to one aspect of the present disclosure includes an element body having a pair of end surfaces facing each other in a first direction, a mounting surface and a main surface facing each other in a second direction, and a pair of side surfaces facing each other in a third direction, a pair of terminal electrodes disposed on the mounting surface of the element body, and a coil disposed in the element body and electrically connected to the pair of terminal electrodes, wherein the coil includes a plurality of first wiring portions disposed on the main surface side and disposed side by side in the third direction, a plurality of second wiring portions disposed on the mounting surface side and disposed side by side in the third direction, and a plurality of connection portions that extend in the second direction and connect the first wiring portions with the second wiring portions which correspond to each other, and when a width of the second wiring portion in the third direction is equal to or greater than a width of the first wiring portion in the third direction, a distance between a pair of the second wiring portions adjacent in the third direction is greater than a distance between a pair of the first wiring portions adjacent in the third direction.

In the laminated coil component, a stray capacitance may be formed between the terminal electrodes disposed on the mounting surface and the second wiring portion disposed on the mounting surface side. In such a configuration, in the laminated coil component according to one aspect of the present disclosure, when the width of the second wiring portion in the third direction is equal to or greater than the width of the first wiring portion in the third direction, a distance between one pair of second wiring portions adjacent in the third direction is greater than a distance between one pair of first wiring portions adjacent in the third direction. Thus, in the laminated coil component, the stray capacitance formed between the adjacent second wiring portions can be reduced. Therefore, in the laminated coil component, the decrease in the self-resonant frequency can be suppressed. Therefore, in the laminated coil component, the Q characteristic in the high frequency range can be improved. As a result, the characteristics in the laminated coil component can be improved.

In one embodiment, a thickness of the second wiring portion in the second direction may be greater than a thickness of the first wiring portion in the second direction. In such a configuration, even when the width of the second wiring portion in the third direction is smaller than the width of the first wiring portion in the third direction, a cross-sectional area of the second wiring portion can be secured. Thus, an increase in electrical resistance of the second wiring portion can be suppressed.

In one embodiment, a thickness of the second wiring portion in the second direction may be smaller than a thickness of the first wiring portion in the second direction. In such a configuration, a distance between the second wiring portion and the terminal electrode can be secured. Therefore, the stray capacitance formed between the second wiring portion and the terminal electrode can be reduced.

In one embodiment, the number of the plurality of first wiring portions may be greater than the number of the plurality of second wiring portions.

In one embodiment, a distance between a pair of the connection portions adjacent in the third direction may be greater on the mounting surface side than on the main surface side. In such a configuration, the stray capacitance formed between the adjacent connection portions can be reduced on the mounting surface side of the connection portions.

In one embodiment, a width of the connection portion in the third direction may decrease from the main surface side toward the mounting surface. In such a configuration, a distance between one pair of connection portions adjacent in the third direction can be made greater on the mounting surface side than on the main surface side. Thus, the stray capacitance formed between adjacent connection portions can be reduced on the mounting surface side of the connection portions.

In one embodiment, at least one of the pair of connection portions adjacent in the third direction may be inclined with respect to the second direction when seen in the first direction. In such a configuration, the distance between one pair of connection portions adjacent in the third direction can be made greater on the mounting surface side than on the main surface side. Thus, the stray capacitance formed between adjacent connection portions can be reduced on the mounting surface side of the connection portions.

According to one aspect of the present disclosure, it is possible to improve the characteristics.

### BRIEF DESCRIPTION OF THE DRAWINGS

FIG. 1 is a perspective view of a laminated coil component according to one embodiment.

FIG. 2 is a view of a coil seen in a first direction.

FIG. 3 is a view of a coil of a laminated coil component according to another embodiment seen in the first direction.

FIG. 4 is a view of a coil of a laminated coil component according to yet another embodiment seen in the first direction.

FIG. 5 is a view of a coil of a laminated coil component according to still another embodiment seen in the first direction.

FIG. 6 is a view of a coil of a laminated coil component according to still another embodiment seen in the first direction.

### DETAILED DESCRIPTION

Exemplary embodiments of the present disclosure will be described in detail below with reference to the accompanying drawings. In the description of the drawings, the same or corresponding elements are designated by the same reference numerals, and overlapping descriptions thereof will be omitted.

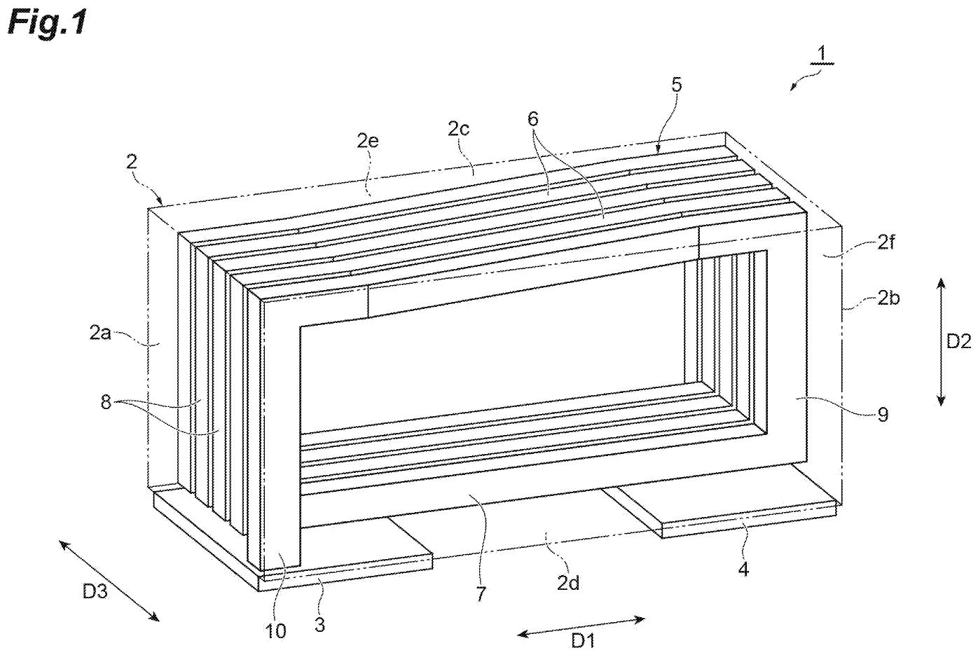

A laminated coil component according to the present embodiment will be described with reference to FIG. 1. FIG. 1 is a perspective view of a laminated coil component according to one embodiment. As shown in FIG. 1, the laminated coil component 1 includes an element body 2, a first terminal electrode 3, and a second terminal electrode 4, a coil 5, a first connection portion 10, and a second connection portion (not shown). In FIG. 1, the element body 2 is indicated by an alternating long and two short dashes line for convenience of description.

The element body 2 has a rectangular parallelepiped shape. The rectangular parallelepiped shape includes a rectangular parallelepiped shape with chamfered corners and edges, and a rectangular parallelepiped shape with rounded corners and edges. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, a facing direction of the end surfaces 2a and 2b is defined as a first direction D1, a facing direction of the main surfaces 2c and 2d is defined as a second direction D2, and a facing direction of the side surfaces 2e and 2f is defined as a third direction D3. The first direction D1, the second direction D2, and the third direction D3 are substantially orthogonal to each other.

The end surfaces 2a and 2b extend in the second direction D2 so as to connect the main surfaces 2c and 2d. The end surfaces 2a and 2b also extend in the third direction D3 so as to connect the side surfaces 2e and 2f. The main surfaces 2c and 2d extend in the first direction D1 so as to connect the end surfaces 2a and 2b. The main surfaces 2c and 2d also extend in the third direction D3 so as to connect the side surfaces 2e and 2f. The side surfaces 2e and 2f extend in the first direction D1 so as to connect the end surfaces 2a and 2b. The side surfaces 2e and 2f also extend in the second direction D2 so as to connect the main surfaces 2c and 2d.

The main surface 2d is a mounting surface and is a surface that faces another electronic device (for example, a circuit base material or a laminated electronic component) when the laminated coil component 1 is mounted on another electronic device which is not shown. The end surfaces 2a and 2b are surfaces continuous from the mounting surface (that is, the main surface 2d).

A length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, each of the end surfaces 2a and 2b, the main surfaces 2c and 2d, and the side surfaces 2e and 2f has a rectangular shape. The length of the element body 2 in the second direction D2 may be equivalent to the length of the element body 2 in the third direction D3, or may be longer than the length of the element body 2 in the third direction D3.

In the present embodiment, “equivalent” may be equivalent to values including slight differences or manufacturing errors within a preset range, in addition to being equal. For example, multiple values are defined as equivalent when they fall within ±5% of an average value of the multiple values.

For the element body 2, a plurality of element body layers (not shown) are laminated in the second direction D2. That is, a laminating direction of the element bodies 2 is the second direction D2. In the actual element body 2, the plurality of element body layers may be integrated to such an extent that boundaries between the layers are not visually recognizable, or may be integrated so that the boundaries between the layers are visually recognizable.

The element body layer is a resin layer. A material of the element body layer includes at least one selected from, for example, a liquid crystal polymer, a polyimide resin, crystalline polystyrene, an epoxy-based resin, an acrylic-based resin, a bismaleimide-based resin, and a fluorine-based resin. The element body layer contains filler. The filler is, for example, inorganic filler. Examples of the inorganic filler include silica. The element body layer may not contain the filler.

The element body layer may contain a magnetic material. The magnetic material of the element body layer includes, for example, a Ni—Cu—Zn-based ferrite material, a Ni—Cu—Zn—Mg-based ferrite material, or a Ni—Cu-based ferrite material. The magnetic material of the element body layer may contain, for example, an Fe alloy. The element body layer may contain, for example, a non-magnetic material. The non-magnetic material of the element body layer includes, for example, a glass-ceramic material or a dielectric material.

Each of the first terminal electrode 3 and the second terminal electrode 4 is provided on the element body 2. Each of the first terminal electrode 3 and the second terminal electrode 4 is disposed on a main surface 2d of the element body 2. The first terminal electrode 3 and the second terminal electrode 4 are provided on the element body 2 so as to be separated from each other in the first direction D1. Specifically, the first terminal electrode 3 is disposed on the end surface 2a side of the element body 2. The second terminal electrode 4 is disposed on the end surface 2b side of the element body 2.

Each of the first terminal electrode 3 and the second terminal electrode 4 has a rectangular shape. Each of the first terminal electrode 3 and the second terminal electrode 4 is disposed such that each side thereof follows the first direction D1 or the third direction D3. The first terminal electrode 3 and the second terminal electrode 4 protrude more than the main surface 2d. That is, in the present embodiment, the respective surfaces of the first terminal electrode 3 and the second terminal electrode 4 are not flush with the main surface 2d. The first terminal electrode 3 and the second terminal electrode 4 are made of a conductive material (for example, Cu).

Each of the first terminal electrode 3 and the second terminal electrode 4 may have a plating layer (not shown) containing, for example, Ni, Sn, Au, or the like due to electrolytic plating or electroless plating. The plating layer may include, for example, a Ni plating film containing Ni and covering the first terminal electrode 3 and the second terminal electrode 4, and an Au plating film containing Au and covering the Ni plating film.

The coil 5 is disposed inside the element body 2. The coil 5 has a plurality of first wiring portions 6, a plurality of second wiring portions 7, a plurality of first pillar portions (connection portions) 8, and a plurality of second pillar portions (connection portions) 9. The coil 5 is configured by electrically connecting the first wiring portions 6, the second wiring portions 7, the first pillar portions 8, and the second pillar portions 9. A coil axis of the coil 5 is provided in the third direction D3. The plurality of first wiring portions 6, the plurality of second wiring portions 7, the plurality of first pillar portions 8, and the plurality of second pillar portions 9 are made of a conductive material (for example, Cu). The first wiring portions 6, the second wiring portions 7, the first pillar portions 8, and the second pillar portions 9 are disposed apart from the end surfaces 2a and 2b, the main surfaces 2c and 2d, and the side surfaces 2e and 2f.

Each of the first wiring portions 6 is disposed on the main surface 2c side of the element body 2. Each of the first wiring portions 6 extends in the first direction D1. Each of the first wiring portions 6 connects the first pillar portion 8 with the second pillar portion 9. The first wiring portions 6 span between the first pillar portions 8 and the second pillar portions 9. One end portion of the first wiring portion 6 in an extending direction (an end portion on the end surface 2a side) is connected to one end portion of the first pillar portion 8 (an end portion on the main surface 2c side). The other end portion of the first wiring portion 6 in the extending direction (an end portion on the end surface 2b side) is connected to one end portion of the second pillar portion 9.

Each of the second wiring portions 7 is disposed on the main surface 2d (the mounting surface) side of the element body 2. Each of the second wiring portions 7 extends in the first direction D1. Each of the second wiring portions 7 connects the first pillar portion 8 with the second pillar portion 9. The second wiring portions 7 span between the first pillar portions 8 and the second pillar portions 9. One end portion of the second wiring portion 7 in the extending direction (an end portion on the end surface 2a side) is connected to the other end portion of the first pillar portion 8 (the end portion on the main surface 2d side). The other end portion of the second wiring portion 7 in the extending direction (an end portion on the end surface 2b side) is connected to the other end portion of the second pillar portion 9. The plurality of second wiring portions 7 is one less in number than the plurality of first wiring portions 6. That is, when the number of the first wiring portions 6 is n, the number of the second wiring portions 7 is n−1.

Each of the first pillar portions 8 is disposed on the end surface 2a side of the element body 2. Each of the first pillar portions 8 extends in the second direction D2. The first pillar portions 8 connect the first wiring portions 6 with the second wiring portions 7. One end portion of the first pillar portions 8 is connected to one end portion of the first wiring portions 6. The other end portion of the first pillar portion 8 is connected to one end portion of the second wiring portion 7.

Each of the second pillar portions 9 is disposed on the end surface 2b side of the element body 2. The second pillar portion 9 connects the first wiring portion 6 with the second wiring portion 7. One end portion of the second pillar portion 9 is connected to the other end portion of the first wiring portion 6. The other end portion of the second pillar portion 9 is connected to the other end portion of the second wiring portion 7.

The first connection portion 10 connects the first terminal electrode 3 with one end portion of the coil 5. The first connection portion 10 is connected to the other end portion of the first pillar portion 8 of the coil 5. The first connection portion 10 is made of a conductive material (for example, Cu). The second connection portion connects the second terminal electrode 4 with the other end portion of the coil 5. The second connection portion is connected to the other end portion of the second pillar portion 9 of the coil 5. The second connection portion is made of a conductive material (for example, Cu).

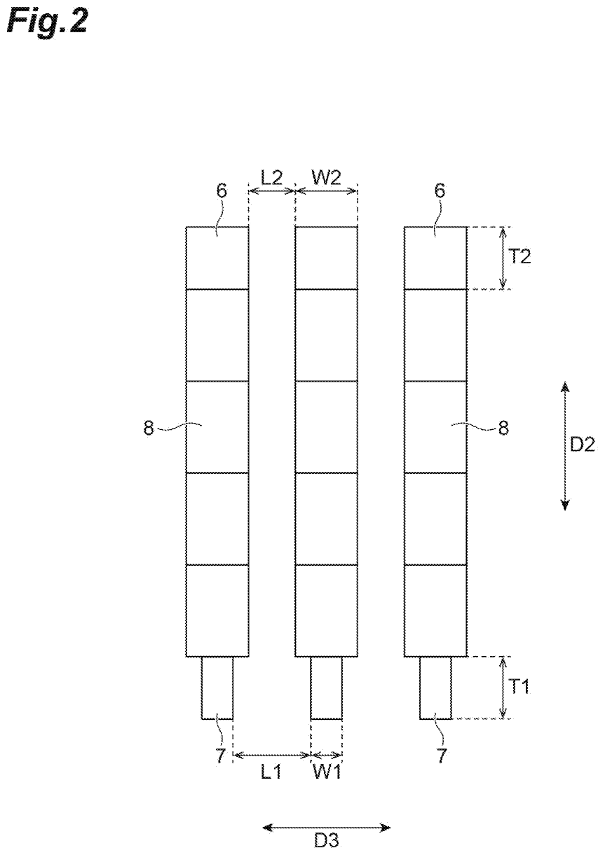

Next, the configuration of the coil 5 will be described in detail. FIG. 2 is a view of a part of the coil 5 seen in the first direction D1. The first pillar portion 8 and the second pillar portion 9 have the same configuration. An example of the configuration (the first wiring portions 6, the second wiring portions 7, the first pillar portions 8) when the coil 5 is seen from the end surface 2a side will be described below. In FIG. 2, the first pillar portions 8 are shown so that they are configured of a plurality of members (parts) (a plurality of members are laminated). This is because the first pillar portions 8 are formed in stages using a photolithographic method in the present embodiment. In the actual first pillar portions 8, they may be integrated so that boundaries therebetween cannot be visually recognized, or may be integrated so that the boundaries can be visually recognized.

As shown in FIG. 2, in the coil 5 of the laminated coil component 1, a width W1 of the second wiring portion 7 in the third direction D3 is smaller than a width W2 of the first wiring portion 6 in the third direction D3 (W1<W2). In the example shown in FIG. 2, the width of the first pillar portion 8 in the third direction D3 is equal to the width W2 of the first wiring portion 6 in the third direction D3. That is, in the present embodiment, the width W1 of the second wiring portion 7 in the third direction D3 is smaller than the width of the first pillar portion 8 in the third direction D3. The first pillar portion 8 extends in the second direction D2.

With the above configuration, in the coil 5, a distance L1 between one pair of second wiring portions 7 adjacent in the third direction D3 is greater (longer) than a distance L2 between one pair of first wiring portions 6 adjacent in the third direction D3 (L1>L2). In the coil 5, it can be said that the distance L1 between the pair of second wiring portions 7 adjacent in the third direction D3 is greater than the distance between one pair of first pillar portions 8 adjacent in the third direction D3. The distance L1 between the pair of second wiring portions 7 adjacent in the third direction D3 is a distance between positions at which the pair of second wiring portions 7 are closest in the third direction D3. Similarly, the distance L2 between the pair of first wiring portions 6 adjacent in the third direction D3 is a distance between positions at which the pair of first wiring portions 6 are closest in the third direction D3.

A thickness T1 of the second wiring portion 7 in the second direction D2 is greater (thicker) than a thickness T2 of the first wiring portion 6 in the second direction D2. In other words, the thickness T2 of the first wiring portion 6 in the second direction D2 is smaller (thinner) than the thickness T1 of the second wiring portion 7 in the second direction D2.

The laminated coil component 1 can be manufactured, for example, as follows. The element body 2 can be formed by laminating sheets constituting the element body layers. The coil 5 (the first wiring portions 6, the second wiring portions 7, the first pillar portions 8, the second pillar portions 9), the first connection portion 10, and the second connection portion 11 can be manufactured using a photolithographic method. The “photolithography method” is not limited to the type of mask, or the like, as long as a desired pattern is processed by exposing and developing a layer to be processed containing a photosensitive material.

As described above, in the laminated coil component 1 according to the present embodiment, a stray capacitance can be formed between the first terminal electrode 3 and the second terminal electrode 4 disposed on the main surface 2d and the second wiring portions 7 disposed on the main surface 2d side. In such a configuration, in the laminated coil component 1, the width W1 of the second wiring portion 7 in the third direction D3 is smaller than the width W2 of the first wiring portion 6 in the third direction D3. Thus, in the laminated coil component 1, the stray capacitance formed between the adjacent second wiring portions 7 can be reduced. Therefore, in the laminated coil component 1, a decrease in self-resonant frequency can be suppressed. Therefore, in the laminated coil component 1, Q characteristic in a high frequency range can be improved. As a result, the characteristics of the laminated coil component 1 can be improved.

When it is tried to make the laminated coil component 1 more compact (smaller and thinner), the distance between the adjacent second wiring portions 7 may be reduced. In this case, the stray capacitance formed between the adjacent second wiring portions 7 may also increase. In the laminated coil component 1, since the stray capacitance formed between the adjacent second wiring portions 7 can be reduced, the characteristics can be improved even when it is tried to make the laminated coil component 1 more compact.

In the laminated coil component 1 according to the present embodiment, the thickness T1 of the second wiring portion 7 in the second direction D2 is greater than the thickness T2 of the first wiring portion 6 in the second direction D2. In such a configuration, even when the width W1 of the second wiring portion 7 in the third direction D3 is smaller than the width W2 of the first wiring portion 6 in the third direction D3, a cross-sectional area of the second wiring portion 7 can be secured. Therefore, an increase in electrical resistance of the second wiring portion 7 can be suppressed.

Although the embodiment of the present disclosure has been described above, the present disclosure is not necessarily limited to the above-described embodiment, and various modifications can be made without departing from the scope of the present disclosure.

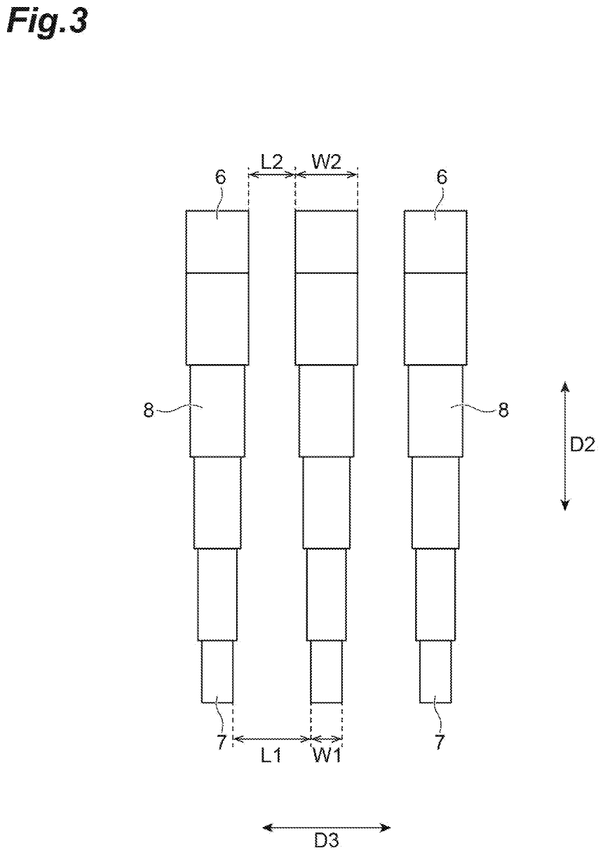

FIG. 3 is a view of a coil of a laminated coil component according to another embodiment seen in the first direction D1. As shown in FIG. 3, the width W1 of the second wiring portion 7 in the third direction D3 is smaller than the width W2 of the first wiring portion 6 in the third direction D3 (W1<W2). The width of the first pillar portion 8 in the third direction D3 is smaller on the second wiring portion 7 side than on the first wiring portion 6 side. Specifically, the width of the first pillar portion 8 in the third direction D3 decreases stepwise from the first wiring portion 6 side toward the second wiring portion 7 side. That is, the width of the first pillar portion 8 in the third direction D3 narrows from the first wiring portion 6 side toward the second wiring portion 7 side.

With the above configuration, the distance L1 between the pair of second wiring portions 7 adjacent in the third direction D3 is greater (longer) than the distance L2 between the pair of first wiring portions 6 adjacent in the third direction D3 (L1>L2). It can be said that the distance L1 between the pair of second wiring portions 7 adjacent in the third direction D3 is greater than the distance between the pair of first pillar portions 8 adjacent in the third direction D3. The distance between the pair of first pillar portions 8 adjacent in the third direction D3 increases stepwise from the first wiring portion 6 side toward the second wiring portion 7 side. The distance between the pair of first pillar portions 8 adjacent in the third direction D3 may gradually (continuously) increase from the first wiring portion 6 side toward the second wiring portion 7 side. That is, the first pillar portion 8 may have a tapered shape.

In the laminated coil component having the configuration shown in FIG. 3, the width W1 of the second wiring portion 7 in the third direction D3 is smaller than the width W2 of the first wiring portion 6 in the third direction D3. Also, the distance between the pair of first pillar portions 8 adjacent in the third direction D3 increases stepwise from the first wiring portion 6 side toward the second wiring portion 7 side. Thus, the stray capacitance formed between the adjacent second wiring portions 7 can be reduced in the laminated coil component. Therefore, in the laminated coil component, a decrease in the self-resonant frequency can be suppressed. Therefore, in the laminated coil component, the Q characteristic in the high frequency range can be improved. As a result, it is possible to improve the characteristics of the laminated coil component.

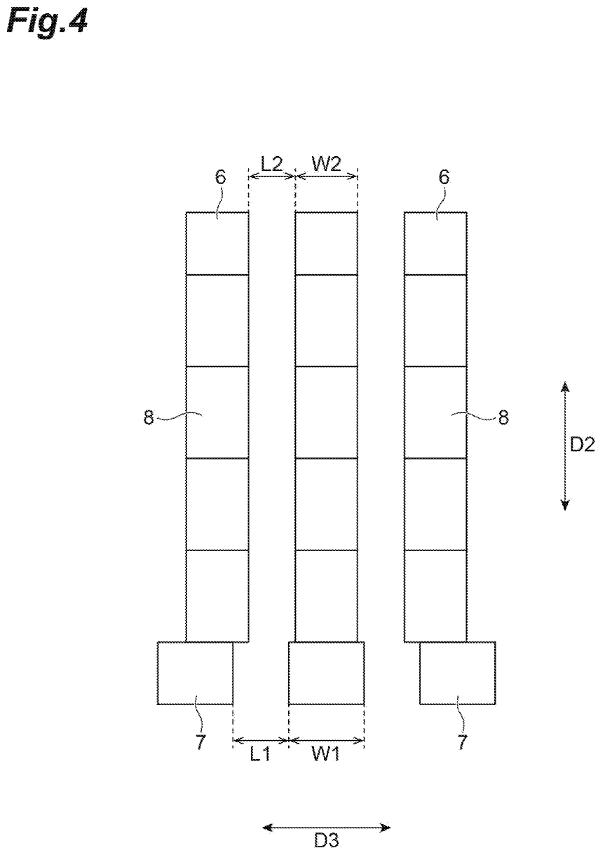

FIG. 4 is a view of a coil of a laminated coil component according to yet another embodiment seen in the first direction D1. As shown in FIG. 4, the width W1 of the second wiring portion 7 in the third direction D3 is equal to or greater than the width W2 of the first wiring portion 6 in the third direction D3 (W1≥W2). In the example shown in FIG. 4, the width W1 of the second wiring portion 7 in the third direction D3 is greater than the width W2 of the first wiring portion 6 in the third direction D3 (W1>W2). The width of the first pillar portion 8 in the third direction D3 is the same as the width W2 of the first wiring portion 6 in the third direction D3. That is, in the present embodiment, the width W1 of the second wiring portion 7 in the third direction D3 is smaller than the width of the first pillar portion 8 in the third direction D3.

The distance L1 between one pair of second wiring portions 7 adjacent in the third direction D3 is greater (longer) than the distance L2 between one pair of first wiring portions 6 adjacent in the third direction D3 (L1>L2). It can be said that the distance L1 between the pair of second wiring portions 7 adjacent in the third direction D3 is greater than the distance between the pair of first pillar portions 8 adjacent in the third direction D3.

In the laminated coil component having the above configuration, a stray capacitance can be formed between the first terminal electrode 3 and the second terminal electrode 4 disposed on the main surface 2d and the second wiring portion 7 disposed on the main surface 2d side. In such a configuration, in the laminated coil component, when the width W1 of the second wiring portion 7 in the third direction D3 is equal to or greater than the width W2 of the first wiring portion 6 in the third direction D3 (W1≥W2), the distance L1 between one pair of second wiring portions 7 adjacent in the third direction D3 is longer than the distance L2 between one pair of first wiring portions 6 adjacent in the third direction D3 (L1>L2). Thus, the stray capacitance formed between the adjacent second wiring portions 7 can be reduced in the laminated coil component. Therefore, in the laminated coil component, a decrease in the self-resonant frequency can be suppressed. Therefore, in the laminated coil component, the Q characteristic in the high frequency range can be improved. As a result, the characteristics of the laminated coil component can be improved.

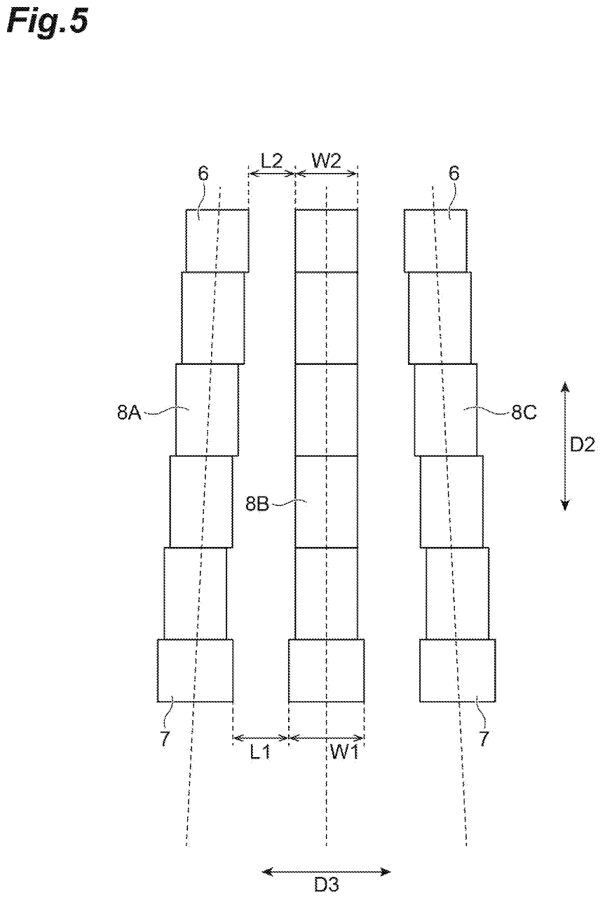

FIG. 5 is a view of a coil of a laminated coil component according to still another embodiment seen from the first direction D1. As shown in FIG. 5, the width W1 of the second wiring portion 7 in the third direction D3 is greater than the width W2 of the first wiring portion 6 in the third direction D3 (W1>W2). In the example shown in FIG. 5, the width of the first pillar portion 8 in the third direction D3 is equal to the width W2 of the first wiring portion 6 in the third direction D3. That is, in the present embodiment, the width W1 of the second wiring portion 7 in the third direction D3 is smaller than the width of the first pillar portion 8 in the third direction D3.

The distance L1 between one pair of second wiring portions 7 adjacent in the third direction D3 is greater (longer) than the distance L2 between one pair of first wiring portions 6 adjacent in the third direction D3 (D1>D2). The distance between the pair of first pillar portions 8 adjacent in the third direction D3 increases stepwise from the first wiring portion 6 side toward the second wiring portion 7 side. In the example shown in FIG. 5, the first pillar portion 8 is divided into a first pillar portion 8A, a first pillar portion 8B, and a first pillar portion 8C for convenience of description. As shown in FIG. 5, the first pillar portion 8A and the first pillar portion 8C are inclined with respect to the first pillar portion 8B. The first pillar portion 8B extends in the second direction D2. Therefore, it can be said that the first pillar portion 8A and the first pillar portion 8C are inclined with respect to the second direction D2. With such a configuration, the distance between the pair of first pillar portions 8 adjacent in the third direction D3 increases stepwise from the first wiring portion 6 side toward the second wiring portion 7 side.

In the laminated coil component having the above configuration, a stray capacitance can be formed between the first terminal electrode 3 and the second terminal electrode 4 disposed on the main surface 2d and the second wiring portion 7 disposed on the main surface 2d side. In this configuration, in the laminated coil component, when the width W1 of the second wiring portion 7 in the third direction D3 is equal to or greater than the width W2 of the first wiring portion 6 in the third direction D3 (W1≥W2), the distance L1 between one pair of second wiring portions 7 adjacent in the third direction D3 is longer than the distance L2 between one pair of first wiring portions 6 adjacent in the third direction D3 (D1>D2). Thus, the stray capacitance formed between the adjacent second wiring portions 7 can be reduced in the laminated coil component. Therefore, in the laminated coil component, the decrease in the self-resonant frequency can be suppressed. Therefore, in the laminated coil component, the Q characteristic in the high frequency range can be improved. As a result, the characteristics in the laminated coil component can be improved.

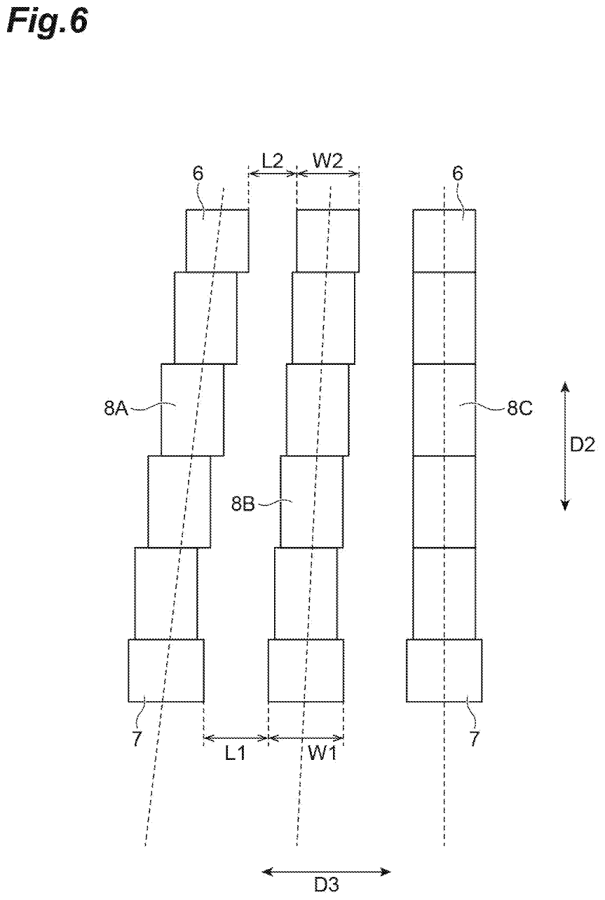

FIG. 6 is a view of a coil of a laminated coil component according to still another embodiment seen from the first direction D1. In the example shown in FIG. 6, the first pillar portion 8 is divided into a first pillar portion 8A, a first pillar portion 8B, and a first pillar portion 8C for convenience of description. As shown in FIG. 6, the first pillar portion 8A and the first pillar portion 8B are inclined with respect to the first pillar portion 8C. The first pillar portion 8C extends in the second direction D2. Therefore, it can be said that the first pillar portion 8A and the first pillar portion 8B are inclined with respect to the second direction D2. With such a configuration, the distance between the pair of first pillar portions 8 adjacent in the third direction D3 increases stepwise from the first wiring portion 6 side toward the second wiring portion 7 side.

In the second wiring portion 7 shown in FIGS. 4 to 6, the thickness of the second wiring portion 7 in the second direction D2 may be smaller (thinner) than the thickness of the first wiring portion 6 in the second direction D2. In such a configuration, the distance between the second wiring portion 7 and the first terminal electrode 3 and the second terminal electrode 4 can be secured. Therefore, the stray capacitance formed between the second wiring portion 7 and the first terminal electrode 3 and the second terminal electrode 4 can be reduced.

In the above embodiment, the example in which the first terminal electrode 3 and the second terminal electrode 4 protrude more than the main surface 2d has been described. However, the first terminal electrode 3 and the second terminal electrode 4 may be embedded within the element body 2. That is, the first terminal electrode 3 and the second terminal electrode 4 may be provided to be substantially flush with the main surface 2d. In such a configuration, the plating layer provided on each of the first terminal electrode 3 and the second terminal electrode 4 may protrude more than the main surface 2d.

What is claimed is:

1. A laminated coil component comprising:
an element body having a pair of end surfaces facing each other in a first direction, a mounting surface and a main surface facing each other in a second direction, and a pair of side surfaces facing each other in a third direction;
a pair of terminal electrodes disposed on the mounting surface of the element body; and
a coil disposed in the element body and electrically connected to the pair of terminal electrodes,
wherein the coil includes a plurality of first wiring portions disposed on the main surface side and disposed side by side in the third direction, a plurality of second wiring portions disposed on the mounting surface side and disposed side by side in the third direction, and a plurality of connection portions that extend in the second direction and connect the first wiring portion with the second wiring portion which correspond to each other, and
a width of the second wiring portion in the third direction is smaller than a width of the first wiring portion in the third direction.

2. A laminated coil component comprising:
an element body having a pair of end surfaces facing each other in a first direction, a mounting surface and a main surface facing each other in a second direction, and a pair of side surfaces facing each other in a third direction;
a pair of terminal electrodes disposed on the mounting surface of the element body; and
a coil disposed in the element body and electrically connected to the pair of terminal electrodes,
wherein the coil includes a plurality of first wiring portions disposed on the main surface side and disposed side by side in the third direction, a plurality of second wiring portions disposed on the mounting surface side and disposed side by side in the third direction, and a plurality of connection portions that extend in the second direction and connect the first wiring portion with the second wiring portion which correspond to each other, and
when a width of the second wiring portion in the third direction is equal to or greater than a width of the first wiring portion in the third direction, a distance between a pair of the second wiring portions adjacent in the third direction is greater than a distance between a pair of the first wiring portions adjacent in the third direction.

3. The laminated coil component according to claim 1, wherein a thickness of the second wiring portion in the second direction is greater than a thickness of the first wiring portion in the second direction.

4. The laminated coil component according to claim 2, wherein a thickness of the second wiring portion in the second direction is smaller than a thickness of the first wiring portion in the second direction.

5. The laminated coil component according to claim 1, wherein the number of the plurality of first wiring portions is greater than the number of the plurality of second wiring portions.

6. The laminated coil component according to claim 1, wherein a distance between a pair of the connection portions adjacent in the third direction is greater on the mounting surface side than on the main surface side.

7. The laminated coil component according to claim 6, wherein a width of the connection portion in the third direction decreases from the main surface side toward the mounting surface.

8. The laminated coil component according to claim 6, wherein at least one of the pair of connection portions adjacent in the third direction is inclined with respect to the second direction when seen in the first direction.
